(19) United States
(12) Patent Application Publication
(10) Pub. No.: US 2026/0194684 A1
(43) Pub. Date: Jul. 9, 2026

(54) Techniques for Determining Carbon to Oxygen Ratio Using Neutron-Induced Gamma Ray Spectroscopy

(71) Applicant: Weatherford Technology Holdings, LLC, Houston, TX (US)

(72) Inventor: Paul Baturin, Houston, TX (US)

(21) Appl. No.: 19/016,959

(22) Filed: Jan. 10, 2025

Related U.S. Application Data
(60) Provisional application No. 63/742,739, filed on Jan. 7, 2025.

(51) Int. Cl. G01V 5/10; G01N 23/20066

(52) U.S. Cl. CPC G01V 5/102; G01N 23/20066; G01N 2223/1016

(57) ABSTRACT

Methods and systems for determining a carbon-to-oxygen (C/O) ratio within a formation are described. The methods and systems use a pulsed neutron tool conveyed within a borehole in the formation to measure gamma rays induced by inelastic scattering events between pulsed neutrons and elements within the formation. The resulting inelastic scattering spectra are treated to remove baseline counts arising from interactions occurring within scintillation materials of the detector and are then deconvolved using elemental standard spectra that are similarly detrended to remove baseline contributions.

### CROSS REFERENCE TO RELATED APPLICATIONS

This is a non-provisional of U.S. Provisional Patent Application Ser. No. 63/742,739, filed Jan. 7, 2025, which is incorporated by reference in its entirety, and to which priority is claimed.

### FIELD OF THE TECHNOLOGY

The present application relates to techniques for determining chemical composition near an oil or gas wellbore from nuclear spectroscopy measurements, and more specifically for determining carbon to oxygen ratio.

### INTRODUCTION

The carbon to oxygen (C/O) ratio is known in the oil and gas industry as an indicator of hydrocarbon saturation within a formation. Techniques for using pulsed neutron-induced gamma spectroscopy have been used in the prior art for determining the C/O ratio of materials within a formation. However, those techniques suffer from several drawbacks, as discussed below. This disclosure provides improved methods and systems for using pulsed neutron gamma spectroscopy to determine C/O ratios.

### SUMMARY

Disclosed herein is a method of determining a ratio of at least two elements in a formation traversed by a wellbore, the method comprising: conveying a pulsed neutron tool within the wellbore, wherein the pulsed neutron tool comprises a pulsed neutron generator (PNG) and a gamma radiation detector; using the PNG to irradiate the formation with pulsed neutrons; using the gamma radiation detector to detect gamma rays emitted as a result of interactions of the pulsed neutrons with elements within the formation; using the detected gamma rays to generate an inelastic scattering spectrum, wherein the inelastic scattering spectrum comprises: peaks indicative of gamma rays arising from inelastic scattering interactions between the pulsed neutrons and the at least two elements, and a background signal; removing the background signal from the inelastic scattering spectrum to yield a background-corrected inelastic spectrum; deconvolving the background-corrected inelastic spectrum to yield concentrations of the at least two elements; and determining the ratio of the at least two elements. According to some embodiments, the at least two elements comprise carbon and oxygen. According to some embodiments, using the PNG to irradiate the formation comprises: during a pulse cycle, repeatedly pulsing the PNG for a first duration, followed by a second duration which the PNG is inactive; and following the pulse cycle, allowing the PNG to remain inactive for a third duration. According to some embodiments, detecting the gamma rays comprises detecting gamma rays emitted during the first, second, and third durations. According to some embodiments, the gamma rays detected during the first duration comprise gamma rays arising from inelastic scattering interactions, gamma rays arising from capture interactions, and background radiation, and the gamma rays detected during the first duration comprise gamma rays arising from capture interactions, and background radiation, and the gamma rays detected during the third duration comprises naturally occurring radiation. According to some embodiments, generating an inelastic scattering spectrum comprises subtracting gamma rays arising from capture interactions and naturally occurring radiation from the gamma rays detected during the first duration. According to some embodiments, removing the background signal from the inelastic scattering spectrum comprises using a Sensitive Nonlinear Iterative Peak (SNIP) algorithm. According to some embodiments, deconvolving the background-corrected inelastic spectrum comprises using a plurality of elemental standard spectra as basis functions to reconstruct the inelastic spectrum. According to some embodiments, each of the elemental spectra comprise peaks indicative of gamma rays arising from inelastic scattering interactions between the pulsed neutrons and its respective element and a background signal. According to some embodiments, deconvolving the background-corrected inelastic spectrum comprises removing the background signal from each of the elemental standard spectra. According to some embodiments, the elemental standard spectra are simulated spectra. According to some embodiments, the elemental standard spectra are simulated using Monte Carlo methods. According to some embodiments, the at least two elements comprise carbon and oxygen and the method further comprises determining a carbon-to-oxygen ratio. According to some embodiments, the method further comprises determining the ratio at a plurality of locations within the wellbore. According to some embodiments, the method further comprises using the ratios determined at the plurality of locations to construct a log of the ratios as a function of locations within the wellbore. According to some embodiments, the background signal arises from one or more of events occurring within a scintillation material of the gamma radiation detector, and gamma scattering events in the tool's housing and/or the formation. According to some embodiments, the events occurring within the scintillation material comprise one or more of Compton scattering events, bremsstrahlung radiation, and characteristic X-rays.

Also disclosed herein is a system for determining a ratio of at least two elements in a formation traversed by a wellbore, the system comprising: a pulsed neutron generator (PNG) configured to irradiate the formation with pulsed neutrons; a gamma radiation detector configured to detect gamma rays emitted from the formation as a result of interactions of the pulsed neutrons with elements within the formation; a computing device configured to: receive data indicative of the detected gamma rays, use the data to generate an inelastic scattering spectrum, wherein the inelastic scattering spectrum comprises: peaks indicative of gamma rays arising from inelastic scattering interactions between the pulsed neutrons and the at least two elements, and a background signal, remove the background signal from the inelastic scattering spectrum to yield a background-corrected inelastic spectrum, deconvolve the background-corrected inelastic spectrum to yield concentrations of the at least two elements, and determine the ratio of the at least two elements. According to some embodiments, the at least two elements comprise carbon and oxygen. According to some embodiments, the PNG is configured so that: during a pulse cycle, the PNG repeatedly pulses for a first duration, followed by a second duration during which the PNG is inactive; and following the pulse cycle, the PNG remains inactive for a third duration. According to some embodiments, detecting the gamma rays comprises detecting gamma rays emitted during the first, second, and third durations. According to some embodiments, the gamma rays detected during the first duration comprise gamma rays arising from inelastic scattering interactions, gamma rays arising from capture interactions, and background radiation, and the gamma rays detected during the first duration comprise gamma rays arising from capture interactions, and background radiation, and the gamma rays detected during the third duration comprise naturally occurring radiation. According to some embodiments, generating an inelastic scattering spectrum comprises subtracting gamma rays arising from capture interactions and naturally occurring radiation from the gamma rays detected during the first duration. According to some embodiments, removing the background signal from the inelastic scattering spectrum comprises using a Sensitive Nonlinear Iterative Peak (SNIP) algorithm. According to some embodiments, deconvolving the background-corrected inelastic spectrum comprises using a plurality of elemental standard spectra as basis functions to reconstruct the inelastic spectrum. According to some embodiments, each of the elemental spectra comprise peaks indicative of gamma rays arising from inelastic scattering interactions between the pulsed neutrons and its respective element and a background signal. According to some embodiments, deconvolving the background-corrected inelastic spectrum comprises removing the background signal from each of the elemental standard spectra. According to some embodiments, the elemental standard spectra are simulated spectra. According to some embodiments, the elemental standard spectra are simulated using Monte Carlo methods. According to some embodiments, the at least two elements comprise carbon and oxygen and the system is configured to determine a carbon-to-oxygen ratio. According to some embodiments, the background signal arises from one or more of events occurring within a scintillation material of the gamma radiation detector, the tool's housing, and/or the formation. According to some embodiments, the events occurring within the scintillation material comprise one or more of Compton scattering events, bremsstrahlung radiation, and characteristic X-rays.

The disclosure also provides non-transitory computer readable medium comprising instructions, which when executed on a computing device, cause the computing device to perform the above-described methods.

### BRIEF DESCRIPTION OF THE DRAWINGS

FIG. 1 shows an overview of the various components associated with the deployment of a pulsed-neutron tool in a wellbore.

FIG. 2 shows different types of interactions between neutrons emitted by the pulsed-neutron tool and the nuclei of neighboring elements that are detectable by the tool.

FIG. 3A shows an example of the timing of the pulsed neutron generator (PNG) and detection of induced gamma rays. FIG. 3B shows gamma counts detected during the burst interval and in the capture interval.

FIG. 4 shows an example of an elemental spectrum during the burst interval.

FIG. 5 shows an example of an elemental spectrum during the capture interval.

FIGS. 6A and 6B show various characteristic inelastic and capture elemental spectra, respectively.

FIG. 7 is a flowchart illustrating a method of determining C/O ratios using neutron-induced gamma ray spectroscopy.

FIG. 8 shows a background-corrected spectrum of an aluminum elemental standard.

FIG. 9 shows a background-corrected inelastic scattering spectrum.

### DETAILED DESCRIPTION

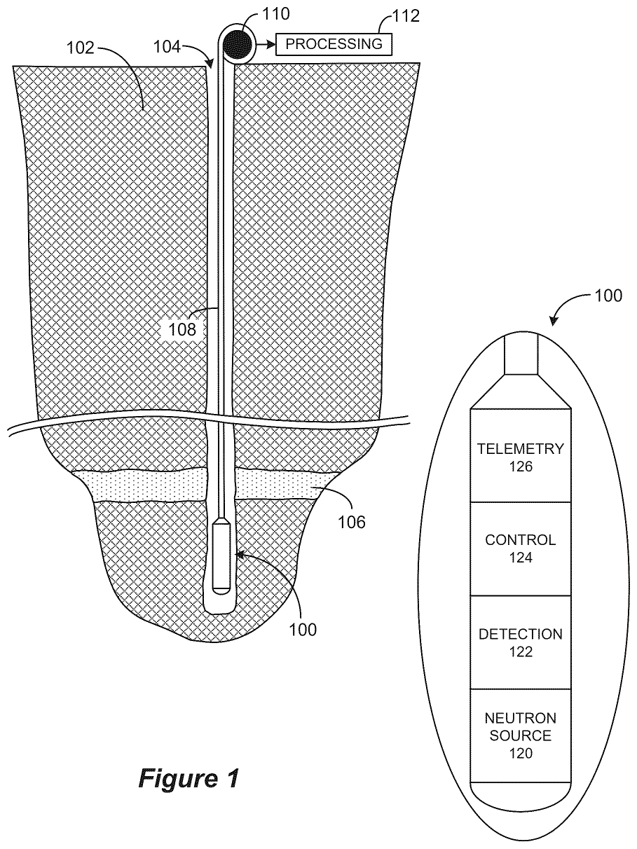

The present disclosure relates to using a neutron induced gamma ray spectroscopy to determine carbon to oxygen (C/O) ratios within a formation, which as mentioned above, is an indicator of oil saturation. Pulsed neutron tools use the physical principles of nuclear spectroscopy to ascertain the chemical content of subsurface formations. FIG. 1 illustrates a pulsed-neutron logging tool 100 used for obtaining induced gamma radiation measurements within a geological formation 102 adjacent to a wellbore 104. Such measurements provide valuable information regarding natural resources that may be located at various depths along the wellbore 104. For example, measurements that are recorded when the tool 100 is adjacent to the region 106 may indicate that it is likely to contain desirable natural resources. In the illustrated embodiment, the tool 100 is conveyed within the wellbore 104 by a wireline logging cable 108 that is connected to draw works 110 and a processing system 112 at the surface. The wireline logging cable 108 supports the weight of the tool 100 and acts as a data conduit between the processing system 112 and the tool 100. While the tool 100 is illustrated as being conveyed via wireline 108, it will be understood that the tool 100 could also be conveyed into the wellbore 104 in other ways such as via coiled tubing, drill string (e.g., during a logging while drilling operation), etc. According to some embodiments, the pulsed-neutron logging tool 100 may be run as part of a logging string that includes the spectral gamma ray, density, neutron porosity tools, or other equipment known in the art.

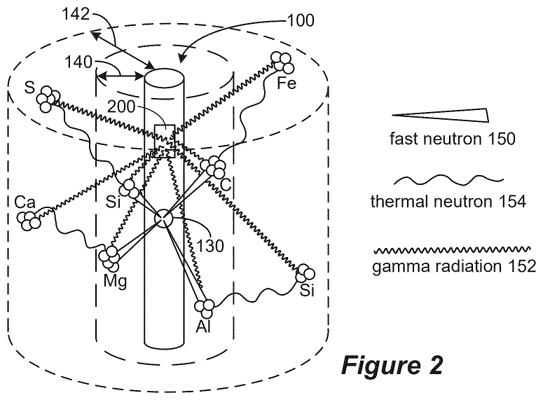

The tool 100 includes a neutron source section 120, a detection section 122, a control section 124, and a telemetry section 126. The neutron source section 120 includes a neutron source 130 (FIG. 2) that bombards the formation adjacent the tool 100 with high energy neutrons (e.g., 14 MeV). The neutron source 130 is typically a pulsed neutron generator (PNG), which enables the precisely timed emission of neutrons. While a chemical neutron source may be used, there are numerous advantages for using a PNG instead of a chemical neutron source. With a PNG the output flux of neutrons can be controlled electronically, and thus the number of gamma rays emitted by the formation can be paired to the fast electronics of the detector system. Since the outgoing neutrons generally have energies of about 14 MeV, they can generate a complete spectrum of inelastic gamma rays before slowing down to thermal energies, where they are captured. Included among the inelastic gamma rays are carbon, aluminum, magnesium, silicon, and oxygen, all of which may be important for analyzing the properties of the formation. Obtaining a meaningful set of inelastic gamma rays from a chemical neutron source is extremely difficult. Another advantage of the PNG is that the on-off cycle of the generator can be controlled, allowing the creation of a clean capture spectrum. Using a pulsed neutron generator is also much safer, as there is no possibility of losing a chemical source downhole.

The detection section 122 includes one or more detectors that detect gamma radiation that is emitted because of interactions between emitted neutrons and the nuclei of formation elements. According to some embodiments, the detector(s) may be lanthanum bromide (LaBr₃) gamma ray detectors (i.e., one or more photomultiplier tubes (PMTs) equipped with LaBr₃ scintillation materials). LaBr₃ (Ce) can provide excellent performance for a nuclear spectroscopy system due to its outstanding properties, which include notably high density (5.08 g/cm3 density), excellent energy resolution (~3% FWHM at 0.662 MeV), and its ultra-fast decay time (16 nanoseconds). It also provides over 90% of its normal light yield at temperatures up to 350° F. (177° C.). It should be appreciated that other scintillating materials may be used. The control section 124 includes control circuitry that controls the operation of the neutron source section 120, detection section 122, and telemetry section 126. The telemetry section 126 includes modulation and demodulation circuitry for sending and receiving electrical signals to and from a remote device such as the processing system 112 (e.g., via wireline 108).

It should be noted that embodiments of the disclosed methods are implemented using one or more information processors, which may be any information processor known in the art, such as one or more microprocessors. Examples of microprocessors include dual-core and quad-core processors and the like. Certain embodiments of the present disclosure may be implemented with a hardware environment that includes an information processor, an information storage medium, an input device, processor memory, and may include peripheral information storage medium. The hardware environment may be downhole, at the surface, and/or at a remote location. Moreover, the several components of the hardware environment may be distributed among those locations. The input device may be any information reader or user input device, such as data card reader, keyboard, USB port, etc. The information storage medium stores information provided by the detectors. The information storage medium may be any standard computer information storage device, such as a ROM, USB drive, memory stick, hard disk, removable RAM, EPROMS, EAROMs, EEPROM, flash memories, and optical disks or other commonly used memory storage system known to one of ordinary skill in the art including Internet-based storage. Embodiments of the information storage medium, referred to herein as a non-transitory computer readable medium, may store a computer program comprising instructions that when executed causes the information processor to execute the disclosed methods. Examples of non-transitory computer readable mediums be any standard computer information storage device, such as a USB drive, memory stick, hard disk, removable RAM, or other commonly used memory storage system known to one of ordinary skill in the art including Internet-based storage. Information processor may be any form of computer or mathematical processing hardware, including Internet-based hardware. When the program is loaded from information storage medium into processor memory (e.g. computer RAM), the program, when executed, causes information processor to retrieve detector information from either information storage medium or peripheral information storage medium and execute the disclosed methods. Information processor may be located on the surface, downhole, and/or at a remote location.

Generally, the techniques described herein may be practiced with any tool configuration known in the art that includes a PNG for producing high energy pulsed neutrons and one or more detectors configured to detect induced gamma radiation. According to some embodiments, the length of the tool can be 11.5 feet, for example, and its diameter can be 3.25 inches. According to some embodiments, the distance between the neutron source 120 and the detection section 122, as well as a significant amount of internal shielding, may be optimized based upon modeling, such as Monte Carlo modeling. According to some embodiments, a boron coating may be applied to the housing near the generator-detector system. Consequently, gamma rays from the housing material from slow, or thermal, neutrons can be eliminated, resulting in a significantly improved capture energy spectrum. According to some embodiments, the tool may be configured with multiple detectors spaced different distances from the PNG. An example of such a tool is Weatherford's Raptor cased hole evaluation system (Weatherford International, Houston, TX).

FIG. 2 provides a simplified view of the interactions between neutrons emitted by the tool 100 and the nuclei of neighboring atoms in the formation. Nearer to the neutron source 130 (e.g., within the radius 140), fast-moving neutrons 150 are scattered through inelastic and elastic collisions with the nuclei of atoms in the borehole and in the formation. When inelastic scattering occurs, a portion of the neutron's kinetic energy is transferred to the nucleus of the atom with which it collides, decreasing the energy of the neutron. Often, at least a portion of the energy transferred from the incident neutron to the atom's nucleus briefly activates the nucleus to an unstable, excited state. When the nucleus relaxes back to a stable, ground state, it may emit gamma radiation 152 with energy that is characteristic of the atom. As the neutrons move away from the neutron source 130 and continue to lose energy, they reach thermal equilibrium with the surrounding medium. These “thermal neutrons” 154 may eventually be absorbed, i.e., “captured” by the nuclei of neighboring atoms, resulting in new isotopes of the atoms. The capture of a thermal neutron often results in the emission of gamma radiation 152 with energy that is again characteristic of the atom that captured the neutron. The different elements that interact with neutrons in the ways shown in FIG. 2 are described as “detection elements” because the gamma radiation that they produce is detectable and can be attributed to the type of element that resulted in the gamma radiation as described below.

Gamma radiation refers generally to high-energy electromagnetic radiation having an energy level that exceeds 100,000 electron Volts (100 keV). Gamma radiation 152 that is emitted because of the above-described neutron interactions (as well as naturally occurring gamma radiation) generally has an energy between 100 keV and 10 MeV and is detected by the one or more gamma radiation detectors in the tool's 100 detection section 122. Each detector may be placed near the periphery of the tool 100 to minimize the distance between the detector and the gamma radiation source, i.e., the formation 102 traversed by the wellbore 104.

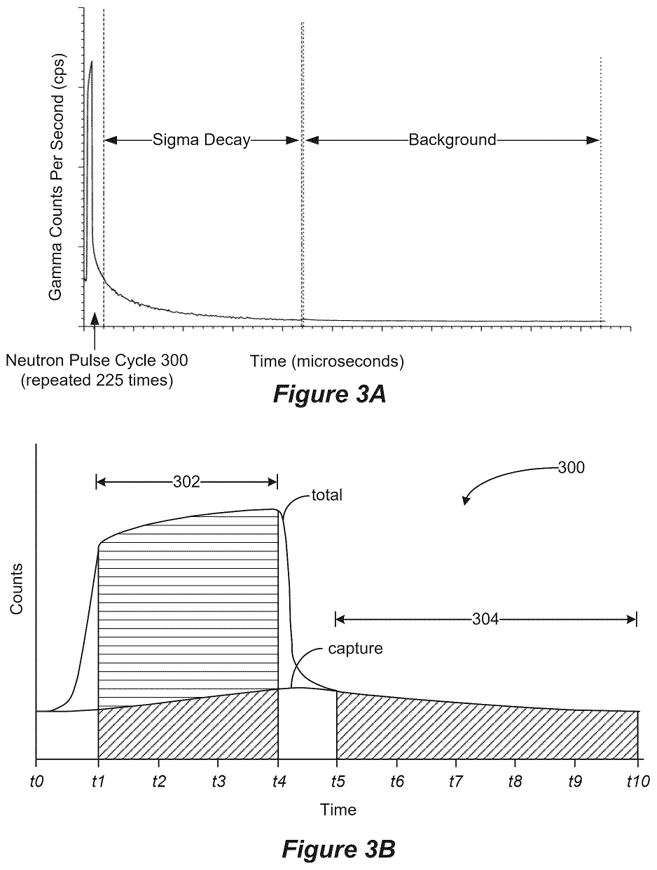

FIG. 3A illustrates an example of timing of pulsed neutron generation for a tool 100. In the illustrated sequence, a neutron pulse cycle 300 is repeated 225 times, though this may differ depending on the tool. Total gamma counts are recorded during the sequence and reflected on the vertical axis in counts per second (CPS). Notice that during the neutron pulse cycle 300, the CPS increases sharply while the PNG is activated and then decays during the time between pulses when the PNG is not activated. According to some embodiments, the neutron source 130 can be pulsed at 5 kHz, so each detection cycle lasts 200 microseconds. The neutron pulse cycle 300 may be followed by a sigma time decay gate (e.g., 0.002 sec.) and a background gate (e.g., 0.003 sec.) where the detector may detect gamma rays originating from naturally.

FIG. 3B illustrates a single neutron pulse cycle 300 and shows an example of the total number of detected gamma radiation photons observed during the time interval when the PNG is active 302 and during the time interval 304 between the bursts, when the PNG is not active. The time interval 302 is referred to herein as the burst interval and contains photons arising from both inelastic scattering events and from capture events. The time interval 304 is referred to herein as the capture interval because it primarily comprises photons arising from capture events. Both intervals 302 and 304 also comprise photons arising from background, as discussed in more detail below. Note that the photons observed during each of the intervals 302 and 304 comprise photons having different energies depending on the elements involved in the capture and inelastic scattering events.

When the PNG's pulse begins at t0, the total number of observed counts is not zero because the tool's one or more detectors 200 are continuing to observe gamma radiation photons that are emitted as a result of neutron capture interactions associated with neutrons that were emitted during the previous neutron pulse(s). Between t0 and t1, gamma radiation detected by the detectors 200 sharply increases, primarily as a result of inelastic collisions between the emitted neutrons and the nuclei of formation and borehole atoms. The one or more detectors 200 are synchronized with the source 130, and between times t1 and t4 (interval 302), the pulses are digitized by an Analog-to-Digital Converter (ADC) and the digitized pulses, or at least their magnitudes, are stored in a memory. The digitized magnitudes enable each gamma radiation photon observed by the detector to be sorted into a channel based on the photon's energy. According to some embodiments, the full 0-9 MeV detection energy range is divided into 256 channels each having an energy range of approximately 35 keV although other numbers of channels (e.g., 512, 1024, or more) with different energy resolutions may also be used. These channels are used to provide the energy spectrum of the various types of photons observed during the burst interval 302.

Between t4 and t5, gamma radiation sharply declines as inelastic collisions decrease to near zero (i.e., as emitted neutrons lose the energy required for inelastic interactions or move to a distance from the detectors at which such interactions are not easily detectable), and, during this time period, no pulses are stored in the memory. Between t5 and t10 (interval 304), the observed gamma radiation is caused almost primarily by neutron capture interactions, and the magnitudes of digitized pulses are again stored in the memory, allowing computation of the energy spectrum of the types of photons observed during the capture interval 304.

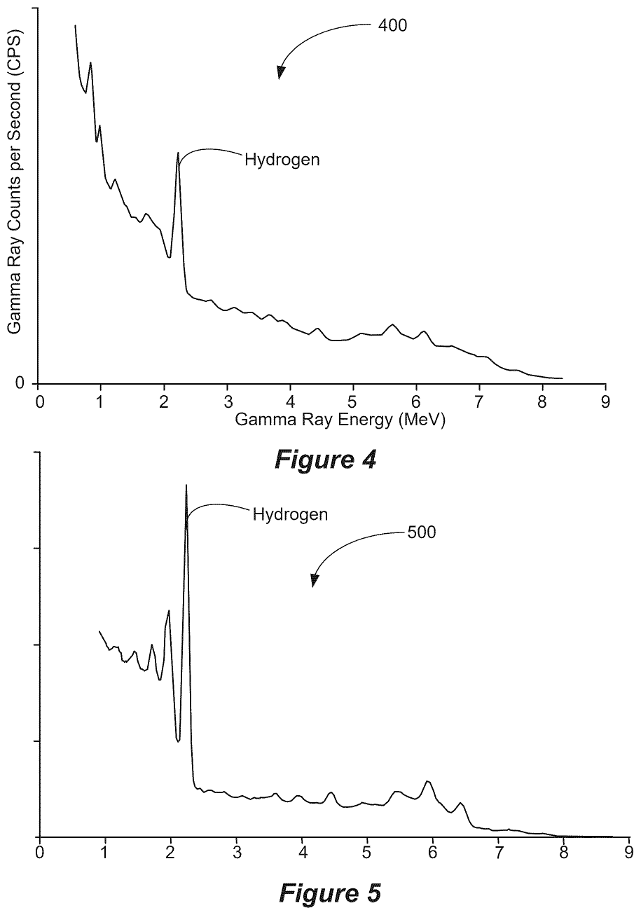

The digitized magnitudes for the pulses detected within the intervals 302 and 304 are provided from memory to a controller (e.g., a microprocessor, a microcontroller, a FPGA, or other logic circuitry). From the data corresponding to the intervals 302 and 304, the controller can generate a raw burst spectrum and a raw capture spectrum, respectively. FIGS. 4 and 5 illustrate a burst spectrum 400 and a capture spectrum 500, respectively. Essentially, the burst spectrum 400 comprises a histogram in which each pulse recorded within the interval 302 increments a count of a particular channel (i.e., energy) based on its magnitude. Similarly, the capture spectrum 500 is essentially a histogram based on the pulses within the interval 304. Each spectrum specifies a quantity of the detected gamma radiation that is within each of a plurality of channels (i.e., energies). As noted above, the energies of the detected photons are indicative of the various nuclei involved in the events that generated the photons.

According to some embodiments, the tool 100 can be calibrated using a stainless-steel barrel filled with water that also contains a carbon-based sleeve. The purpose of the calibration procedure is to verify that the tool is working properly, to measure and record both the temperature and voltage of the PMT, and to set the optimal parameters for the pulsed neutron generator. In some embodiments, the elemental yields for carbon, iron, oxygen, and hydrogen are measured as part of the verification process.

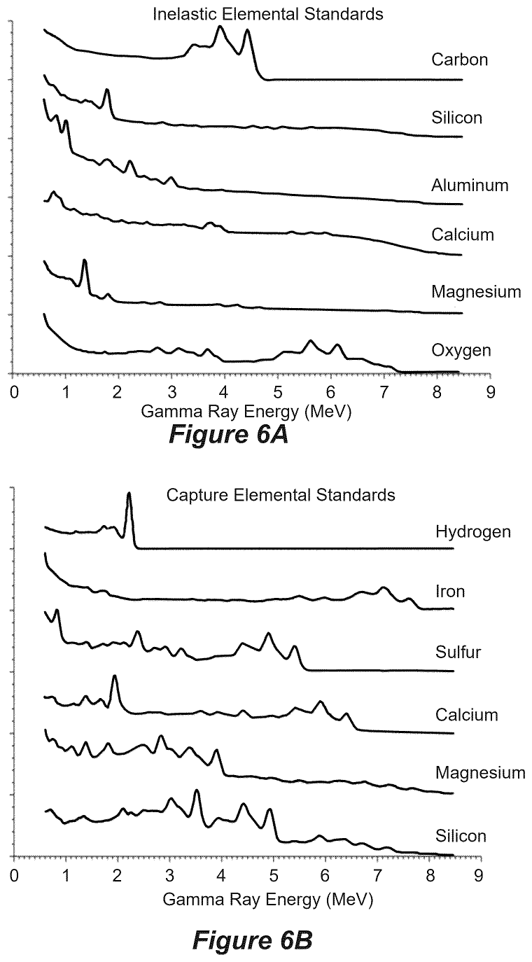

The response of the tool 100 to various elements can be characterized based on measurements of samples of known composition. To properly analyze the data from both capture and inelastic energy spectra, a complete set of elemental standards, or basis vectors, may be generated. An elemental standard can be defined as the response of the tool for a single element. As a group, they are used to extract and separate the fundamental components of a composite spectrum using a matrix inversion process. Each elemental standard for tool 100 can be derived from empirical data with or without the guidance from modeling, such as Monte Carlo N-Particle (MCNP) software or other particle transport modeling software. The produced elemental capture and inelastic spectra can be evaluated using gamma-ray nuclear databases. The gamma-ray cross sections can be found in the literature, such as Reedy, R. C., and Frankle, S.C.: “Prompt Gamma Rays from Radiative Capture of Thermal Neutrons by Elements from Hydrogen through Zinc,” Atomic Data and Nuclear Data Tables, Vol. 80, No. 1, pp. 1-34, January 2002; Choi, H. D., Firestone, R. B., et al.: “Database of Prompt Gamma Rays from Slow Neutron Capture for Elemental Analysis,” International Atomic Energy Agency, Vienna, 2007; and Ahmed, M. R., et al. (Part I), and Demidov, A. M, et al. (Part II): “Atlas of Gamma-Ray Spectra from the Inelastic Scattering of Reactor Fast Neutrons,” Atomizdat, Moscow, 1978. For each such measurement, an attempt can be made to maximize the element for which the standard was being determined. For example, in the case of empirical derivation, a 1-inch thick iron casing of 99% pure iron can be placed into a water tank to extract the capture and inelastic signals for iron. Some of the primary elemental capture and inelastic spectra are displayed in FIGS. 6A and 6B, respectively. It should be noted that more or fewer elemental standards may be used, as is known in the art.

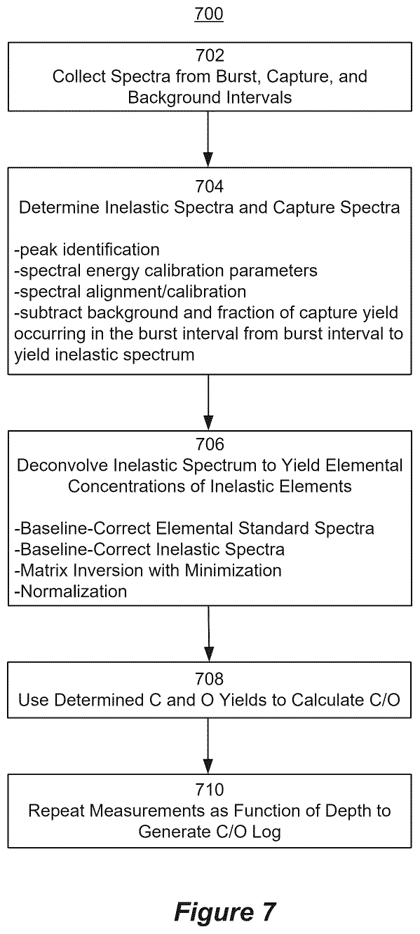

FIG. 7 illustrates an embodiment of a workflow 700 for determining a C/O ratio in a formation from neutron-induced gamma ray spectroscopy, as described herein. Note that the workflow 700 comprises determining a C/O ratio based on a single set of measurements, for example, wherein the relevant spectra are collected at a single depth within the formation. It should also be noted that the workflow detects carbon and oxygen contained both within the rocks and within fluids present within the formation, both of which is termed “in the formation” within this disclosure. Typically, the tool 100 is run through the borehole and spectra are collected at various depths within the borehole to yield a log of C/O ratios at a plurality of depths within the formation. But a single C/O ratio determination is illustrated here for simplicity.

At step 702 the tool 100 is used to collect spectra from the burst, capture, and background intervals, as described above. Step 704 involves using the collected spectra to determine an inelastic spectrum. Referring to the elemental standards shown in FIGS. 6A and 6B, notice that both the carbon and oxygen elemental signatures appear in the inelastic spectrum but neither appear in the capture spectrum. Accordingly, the inelastic spectrum is used to quantify the amounts of carbon and oxygen needed to determine the C/O ratio. As explained above, photons arising due to inelastic scattering interactions are observed during the burst interval 302 (FIG. 3B). But spectra obtained during the burst interval also contain contributions from photons arising from capture events as well as background gamma radiation, which need to be removed to yield the inelastic spectrum.

To yield the inelastic spectrum from the burst interval, the portion of gamma counts arising from capture events and from the background occurring within the burst interval need to be removed. According to some embodiments, the gamma counts arising from capture events within the burst interval are identified by correlating the energy of those counts with energies associated with the same events arising during the capture interval. In other words, the energies corresponding to similar events in the burst and in the capture intervals need to be calibrated to each other. According to some embodiments, similar peaks may be identified within both intervals. For example, referring to FIGS. 4 and 5, a strong peak corresponding to neutron capture by hydrogen atoms occurs in both intervals at an energy just below 2.5 MeV. Identifying this and/or other peaks common to both intervals may be used to align the energy values of both intervals. According to some embodiments, the common peak(s) may be used to derive a multiplicative and an additive coefficient to linearly transform the energy values (i.e., the horizontal axes in FIGS. 4 and 5) of the two durations so that they are calibrated to each other. Once so transformed, the fraction of gamma counts arising from capture events may be subtracted from the burst interval (along with the naturally occurring background counts) to yield the inelastic spectrum. Stated differently, the capture and inelastic spectra may be expressed according to equations 1 and 2:

$${Capture}^{′} = ( Capture Interval ) - Background \qquad ( EQ 1 )$$

$$Inelastic = ( Burst Interval - Background ) - ( Capture\_yield \times {Capture}^{′} ) \qquad ( EQ 2 )$$

where Capture′ is the background-corrected capture spectrum (having naturally occurring radiation removed) and Capture_yield is the fraction of the capture events that occur during the burst interval. In sum, the completion of step 704 of the workflow 700 yields a capture spectrum that is free of background radiation and an inelastic spectrum that is free of both background and capture radiation (which may be referred to herein as a “capture-subtracted fraction (CSF)” inelastic spectrum).

Step 706 involves deconvolving the inelastic spectrum to determine the elemental concentrations of the capture elements (including carbon and oxygen) in the interrogated region of the formation. The inelastic spectrum may include contributions from Al, C, Ca, Fe, Mg, O, and Si, for example. The deconvolution process attempts to reconstruct the observed inelastic spectrum based on contributions of the spectra of each of the inelastic elements contained in the sample. In some embodiments, the deconvolution uses mathematical techniques, such as matrix inversion, to reconstruct the observed inelastic spectrum (such as shown in FIG. 4) using elemental standard spectra of the each of the inelastic elements (such as shown in FIG. 6A) as basis functions. Mathematically, the deconvolution process seeks to solve for the fraction of each element (yᵢ) in the formula:

$$INEL = {\sum }_{i = 0}^{n} {y}_{i} {S}_{i} \qquad EQ ( 3 )$$

where INEL is the observed inelastic spectrum, i is an element (e.g., Al, C, Ca, Fe, Mg, O, or Si), yᵢ is the fractional yield of the i^{th} element, and Sᵢ is the normalized spectral response of the ith element. EQ (3) is constrained by the following condition:

$${\sum }_{i = 0}^{n} {y}_{i} = 1$$

since the total of all of the fractions must sum to 1.

As mentioned above, the elemental standard spectra may be determined empirically based on measured responses of the tool to known samples. Alternatively, they may be derived based on simulations of the tool's responses to various inelastic elements, such as Monte Carlo simulation. In either case, both the elemental standard spectra and the observed inelastic spectrum typically include a background that decays as a function of increasing energy. Such backgrounds are apparent in the inelastic spectrum shown in FIG. 4 and in the spectra of the elemental standards shown in FIG. 6A. This background, frequently referred to as continuum background, is tool-dependent and may be associated with gamma scattering events (e.g., Compton scattering) that occur within the detector's scintillating crystal. Other contributors to the background may include bremsstrahlung radiation, and/or characteristic X-rays that may be detected by the detector. The presence of the background in both the elemental standard spectra and in the observed spectrum means that the elemental reconstruction must account for two competing components the elemental contribution and the background contribution. Typically, empirically determined elemental standard spectra are more likely to reproduce a background slope that is consistent with the tool, since the same detector can be used to produce both the elemental standard spectra and the spectra of the formation. However, the use of empirical measurements of elemental standards suffers from the drawback that it can be difficult to generate contamination-free standards. Elemental standards derived by simulations have the advantage that they can produce contamination-free spectra, but they suffer from the difficulty of simulating a proper background slope.

In embodiments of the methods described in this disclosure, the elemental reconstruction is simplified by removing the continuum background from both the observed spectrum and from elemental standard spectra used to reconstruct the observed spectrum. This ensures that only peaks are used during the reconstruction process. Generally, the background removal and reconstruction may be used with either empirically derived or simulated elemental standard spectra. But in some embodiments, simulated standards may be preferred because, as mentioned above, they are free from contaminants.

Generally, any background removal/detrending technique known in the art may be used to remove the background from the elemental standard and acquired spectrum. Examples of background removal techniques are described in F. Li, Z. Gu, L. Ge, H. Li, X. Tang, X. Lang, B. Hu, Review of recent gamma spectrum unfolding algorithms and their application. Results Phys. 13, 102211 (2019); Steven W. Smith, The Scientist and Engineer's Guide to Digital Signal Processing, Second Edition, California Technical Publishing, (1999), ISBN 0-9660176-7-6; Ryan, C. G. and Clayton, E. and Griffin, W. L. and Sie, S. H. and Cousens, D. R., SNIP, a statistics-sensitive background treatment for the quantitative analysis of PIXE spectra in geoscience applications, Nuclear Instruments and Methods in Physics Research Section B: Beam Interactions with Materials and Atoms, 34:3 (1998); and Yang, S., Lee, J., Yoon, S., & Park, D. S. (2013). Background Removal from XRF Spectrum using the Interval Partitioning and Classifying, Journal of the Institute of Electronics Engineers of Korea, 50, 164-171, for example. Examples of background removal techniques include, without limitation, i) morphology-based methods, ii) Sensitive Nonlinear Iterative Peak (SNIP) algorithms, and iii) threshold-based strategies. Morphology-based techniques utilize erosion and dilation operations to isolate and extract particular shapes, proving beneficial for tasks involving signal denoising and detrending, as described in Smith, et al., referenced above. The SNIP algorithm iteratively approximates the content of a gamma-ray spectrum channel by substituting it with the minimum value between the average of equidistant channel contents and the channel content itself, as described in Ryan, et al. The threshold-based methods employ signal partitioning into intervals with subsequent classification and thresholding performed in the frequency domain, as described in Yang, et al. It is within the ability of a person of skill in the art to select an appropriate background removal technique for removing the background from elemental standards and acquired spectra based on their particular tool and data format. The techniques described herein are not limited to any particular background removal technique or algorithm.

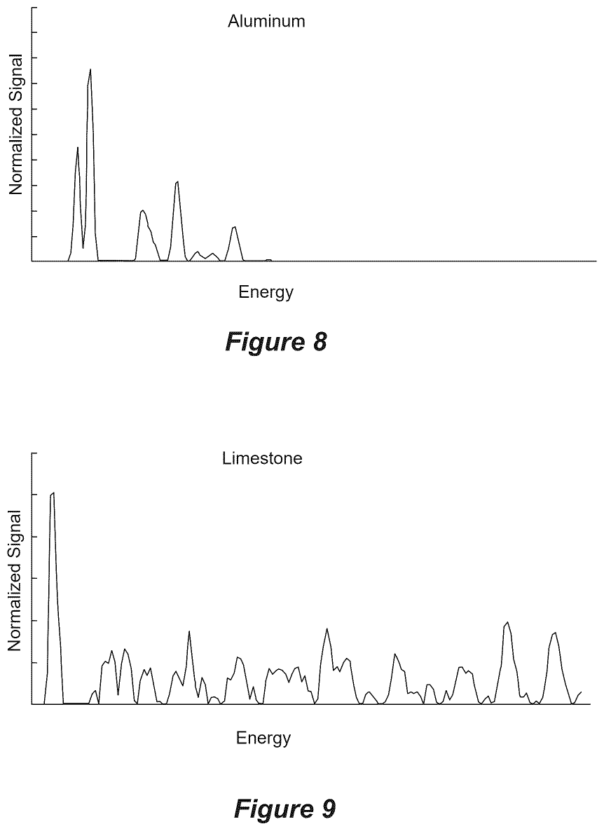

In some embodiments described herein the SNIP algorithm is used to estimate continuum background due to simplicity of its implementation and high efficiency in separating peaks from low frequency background signal. FIGS. 8 and 9 show examples of an aluminum elemental standard and of an inelastic spectrum obtained from limestone rock, respectively. The baselines have been removed from each of the spectra. For reference, compare the aluminum elemental standard shown in FIG. 8 to the aluminum elemental standard included in FIG. 6A and compare the limestone spectrum of FIG. 9 to the example of the inelastic spectrum shown in FIG. 4. According to some embodiments, elemental standards for all of the non-carbon and non-oxygen elements (e.g., Al, Ca, Fe, Mg, S, and Si) may be combined as a single basis function, for example, called “other elements.” In such an embodiment, the elemental standards for each of the “other elements” are baseline corrected and added to form a single basis function that is then used in the deconvolution, which is described below.

Referring again to step 706 of FIG. 7, once the baseline-corrected elemental standards and baseline-corrected inelastic spectra have been obtained, matrix inversion may be used to deconvolve the baseline-corrected inelastic spectrum to determine the yields of each of the elements. As explained above, it is assumed that the baseline-corrected inelastic spectrum is a linear combination of the elemental standards. This system of linear equations can readily be solved using a minimization technique, such as a Weighted Linear Least Squares (WLLS) spectral fit mathematical system, as described in U.S. Pat. No. 11,243,328 (“the '328 patent”), the entire contents of which are incorporated herein by reference.

As explained in the '328 patent, the WLLS method cannot always solve the problem in its simplest form because some of the values of y can numerically become negative when their elemental concentration is small or negligible. This is because the WLLS method solely aims to minimize χ² with no regard to the physics. To alleviate this problem, the Non-Negative Least Squares (NNLS) method can be employed whereby all elemental yields are constrained to be non-negative. Additional techniques, such as the Levenberg-Marquardt nonlinear fitting method may be used with the NNLS method to improve the accuracy of the final result. More specifically, the iterative Levenberg-Marquardt method deals with shifting the spectra, so that each measured spectrum matches the elemental standards with respect to the gamma ray energy scale. See, e.g., Levenberg, Kenneth: “A Method for the Solution of Certain Non-Linear Problems in Least Squares,” Quarterly of Applied Mathematics, 2:164-168, 1944; Marquardt, Donald: “An Algorithm for Least-Squares Estimation of Nonlinear Parameters,” SIAM Journal on Applied Mathematics, 11 (2): 431-441, 1963; and Bevington, P. R.: Data Reduction and Error Analysis for the Physical Sciences, New York: McGraw-Hill, 1992. The deconvolution of the inelastic spectrum determines the contribution (i.e., the number of counts) attributable to each of the detected elements to the total spectrum. The spectrum may be normalized by dividing the counts attributable to each contributing element by the total number of counts in the spectrum to calculate a yield yᵢ for each element such that the total yield adds up to 1 (i.e., 100%).

Step 708 of the workflow 700 comprises using the determined yields for carbon and oxygen to calculate the C/O ratio. Step 710 of the workflow simply involves repeating the measurements at various depths within the wellbore to generate a log of C/O as a function of location (i.e., depth).

The Introduction of this disclosure mentioned that techniques for using pulsed neutron-induced gamma spectroscopy have been used in the prior art for determining the C/O ratio of materials within a formation. However, the prior art techniques are typically based on a cruder method, referred to herein as the “windows” method. The windows method involves placing the energy thresholds on the gamma spectrum to the energies where carbon and oxygen elements are present, integrating over all of the events within the set windows, and calculating the ratio of carbon to oxygen based on the integrated values. The windows methods suffer from several drawbacks. For example, elements other than carbon and oxygen may emit photons within the observed energy windows, which may confound the measurements. The windows methods also do not account for background effects, such as Compton scattering, pair production escape, and x-ray fluorescence.

The methods and systems described herein provide a compromise between the simplicity of the windows methods and their associated drawbacks, and the more complex full elemental spectroscopy measurements and lithology determinations described in the incorporated '328 patent. Importantly, embodiments of the described methods allow for the use of simulated elemental standards without the need to painstakingly match the baselines of the elemental standard and the observed spectra.

Table 1 shows weight fractions determined for several formation types using geochemical spectroscopy (“GCS”), as described in the '328 patent and using the methods described in this disclosure (wherein “BG-Corr1” and “BG-Corr2” denote examples using the background corrections described herein to determine the weight fractions of various samples). Notice that the weight fractions determined using the background correction methods described herein provide good agreement with the values determined using GCS, which is considered in the art to be a high-quality methodology for weight fraction determination. The evaluation of elemental reconstruction encompasses at least five common geological formations: dolomite, limestone, sandstone, granite, and anhydrite. In terms of their elemental structure, limestone and dolomite share a closely related composition, with dolomite identified as CaMg(CO₃)₂ and limestone as CaCO₃. The elemental reconstruction shows that both formations contain more than 20% calcium, along with notable amounts of carbon and oxygen. Dolomite, as anticipated, contains over 10% magnesium, while limestone has nearly no magnesium present. Sandstone and granite are expected to contain either no carbon or only trace amounts, as demonstrated by the reconstructed yields of 1.9%, 0.8%, and 1.8% for the GCS, BG-corr1, and BG-corr2 methods, respectively. The reconstructed sandstone primarily consists of silicon, accounting for over 32%. Although a greater silicon yield was anticipated, the BG-corr-based elemental inversion leads to inaccurate results for calcium, which is found to be approximately 20% instead of the expected zero. In contrast the GCS method accurately determines the calcium content at 0.3%. This is facilitated by an additional constraint on calcium that is calculated during the deconvolution of the capture spectrum and applied in the final deconvolution of the inelastic spectrum during the GCS method. Because the BG-corr method does not incorporate additional constraints, it may indicate an inflated estimation of calcium yield in silicon-bearing formations, particularly sandstone and granite. This issue can be addressed by either implementing an additional calcium constraint, akin to the GCS method, or by adjusting the range of energy thresholds utilized during the reconstruction process. Reconstruction of anhydrite formation showed somewhat overestimated yield of calcium, although the amount of sulfur was within the expected range. Just as with sandstone and granite, the calcium yield may be lowered by the addition of a supplementary constraint.

TABLE 1
Comparison of weight fractions determined using geochemical
spectroscopy, as described in the ′328 Patent with
weight fractions determined using background corrected
inelastic scattering spectra and background corrected
elemental standards, as described in this disclosure.

| | Al | C | Ca | Fe | Mg | O | S | Si |
|---|---|---|---|---|---|---|---|---|
| Dolomite | 0.000 | 0.130 | 0.217 | 0.000 | 0.132 | 0.521 | 0.000 | 0.000 |
| GCS | 0.000 | 0.069 | 0.385 | 0.000 | 0.101 | 0.423 | 0.000 | 0.022 |
| BG-Corr1 | 0.007 | 0.055 | 0.225 | 0.099 | 0.196 | 0.354 | 0.022 | 0.040 |
| BG-Corr2 | 0.001 | 0.040 | 0.311 | 0.077 | 0.189 | 0.317 | 0.035 | 0.029 |
| Limestone | 0.000 | 0.120 | 0.400 | 0.000 | 0.000 | 0.480 | 0.000 | 0.000 |
| GCS | 0.000 | 0.070 | 0.593 | 0.000 | 0.000 | 0.338 | 0.000 | 0.000 |
| BG-Corr1 | 0.016 | 0.962 | 0.330 | 0.021 | 0.024 | 0.428 | 0.050 | 0.035 |
| BG-Corr2 | 0.008 | 0.059 | 0.371 | 0.047 | 0.020 | 0.402 | 0.063 | 0.030 |
| Sandstone | 0.000 | 0.000 | 0.000 | 0.000 | 0.000 | 0.533 | 0.000 | 0.467 |
| GCS | 0.008 | 0.003 | 0.002 | 0.000 | 0.000 | 0.492 | 0.000 | 0.494 |
| BG-Corr1 | 0.000 | 0.000 | 0.228 | 0.050 | 0.046 | 0.318 | 0.034 | 0.326 |
| BG-Corr2 | 0.005 | 0.006 | 0.184 | 0.050 | 0.055 | 0.315 | 0.046 | 0.338 |
| Granite | 0.07 | 0.000 | 0.007 | 0.025 | <0.01 | re- | 0.000 | ~0.34 |
| | | | | | | main- | | |
| | | | | | | der | | |
| GCS | 0.131 | 0.019 | 0.036 | 0.015 | 0.000 | 0.463 | 0.000 | 0.338 |
| BG-Corr1 | 0.003 | 0.008 | 0.192 | 0.089 | 0.058 | 0.354 | 0.025 | 0.270 |
| BG-Corr2 | 0.005 | 0.018 | 0.291 | 0.100 | 0.064 | 0.265 | 0.031 | 0.226 |
| Anhydrite | 0.000 | 0.000 | 0.294 | 0.000 | 0.000 | 0.470 | 0.236 | 0.000 |
| GCS | 0.000 | 0.072 | 0.525 | 0.030 | 0.000 | 0.291 | 0.000 | 0.081 |
| BG-Corr1 | 0.009 | 0.034 | 0.489 | 0.070 | 0.012 | 0.134 | 0.232 | 0.022 |

GCS - weight fractions determined using geochemical spectroscopy, as described in the ′328 Patent; BG-Corr1 and BG-Corr2 - determinations for various samples using background-corrected inelastic determination as described in this disclosure; Dolomite - CaMg(CO₃)₂; Limestone - CaCO₃; Sandstone - SiO₂; Granite - SiO₂ (68-77%), Al₂O₃ (11-14%), limestone (1%), and other (<1%); Anhydrite - CaSO₄.

The evaluation of individual components, as outlined in Table 1, indicated a material-dependent limitation in the accurate estimation of calcium. It is important to acknowledge that the fundamental metrics of success of the disclosed methods are centered around the accurate identification of the carbon-to-oxygen ratio, rather than the meticulous calculation of all elemental elements. As previously discussed, errors in calcium calculations can be rectified through additional constraints, while any discrepancies in carbon and oxygen values can be corrected using material-specific curves identified via a calibration process.

Table 2 compares carbon-to-oxygen ratios determined using geochemical spectroscopy (“GCS”), as described in the '328 patent and using the background correction methods (“BG-Corr”) described in this disclosure. C/O ratios determined using the prior art windows method discussed above are also included in Table 2 for comparison. Notice that the C/O ratios determined using the background correction methods agree closely with the ratios determined using GCS.

TABLE 2
Comparison of carbon-to-oxygen ratios determined using geochemical
spectroscopy, as described in the ′328 Patent with ratios
determined using background corrected inelastic scattering
spectra and background corrected elemental standards, as
described in this disclosure. Values determined using the
windows method (prior art) are also provided.

| | Theo- | | | | | |
|---|---|---|---|---|---|---|
| | ret- | | Windows | Windows | BG-Corr | BG-Corr |
| | ical | GCS | Sample 1 | Sample 2 | Sample 1 | Sample 2 |
| Dolomite | 0.250 | 0.163 | 1.101 | 1.130 | 0.156 | 0.128 |
| Limestone | 0.250 | 0.205 | 1.148 | 1.156 | 0.225 | 0.146 |
| Sandstone | 0 | 0.007 | 0.978 | 0.969 | 0.000 | 0.019 |
| Granite | 0 | 0.041 | 1.012 | 0.987 | 0.023 | 0.067 |
| Anhydrite | N/A | 0.248 | 1.127 | | 0.252 | |

While the invention herein disclosed has been described in terms of specific embodiments and applications thereof, numerous modifications and variations could be made thereto by those skilled in the art without departing from the scope of the invention set forth in the claims.

What is claimed is:

1. A method of determining a ratio of at least two elements in a formation traversed by a wellbore, the method comprising:
conveying a pulsed neutron tool within the wellbore, wherein the pulsed neutron tool comprises a pulsed neutron generator (PNG) and a gamma radiation detector;
using the PNG to irradiate the formation with pulsed neutrons;
using the gamma radiation detector to detect gamma rays emitted as a result of interactions of the pulsed neutrons with elements within the formation;
using the detected gamma rays to generate an inelastic scattering spectrum, wherein the inelastic scattering spectrum comprises:
peaks indicative of gamma rays arising from inelastic scattering interactions between the pulsed neutrons and the at least two elements, and
a background signal;
removing the background signal from the inelastic scattering spectrum to yield a background-corrected inelastic spectrum;
deconvolving the background-corrected inelastic spectrum to yield concentrations of the at least two elements; and
determining the ratio of the at least two elements.

2. The method of claim 1, wherein the at least two elements comprise carbon and oxygen.

3. The method of claim 1, wherein using the PNG to irradiate the formation comprises:
during a pulse cycle, repeatedly pulsing the PNG for a first duration, followed by a second duration which the PNG is inactive; and
following the pulse cycle, allowing the PNG to remain inactive for a third duration.

4. The method of claim 3, wherein detecting the gamma rays comprises detecting gamma rays emitted during the first, second, and third durations.

5. The method of claim 4, wherein:
gamma rays detected during the first duration comprise gamma rays arising from inelastic scattering interactions, gamma rays arising from capture interactions, and background radiation, and
gamma rays detected during the first duration comprise gamma rays arising from capture interactions, and background radiation, and
gamma rays detected during the third duration comprises naturally occurring radiation.

6. The method of claim 5, wherein generating an inelastic scattering spectrum comprises subtracting gamma rays arising from capture interactions and naturally occurring radiation from the gamma rays detected during the first duration.

7. The method of claim 1, wherein removing the background signal from the inelastic scattering spectrum comprises using a Sensitive Nonlinear Iterative Peak (SNIP) algorithm.

8. The method of claim 1, wherein deconvolving the background-corrected inelastic spectrum comprises using a plurality of elemental standard spectra as basis functions to reconstruct the inelastic spectrum and wherein deconvolving the background-corrected inelastic spectrum comprises removing background signal from each of the elemental standard spectra.

9. The method of claim 1, wherein the background signal arises from one or more of events occurring within a scintillation material of the gamma radiation detector, and gamma scattering events in the tool's housing and/or the formation.

10. The method of claim 9, wherein the events occurring within the scintillation material comprise one or more of Compton scattering events, bremsstrahlung radiation, and characteristic X-rays.

11. A system for determining a ratio of at least two elements in a formation traversed by a wellbore, the system comprising:
a pulsed neutron generator (PNG) configured to irradiate the formation with pulsed neutrons;
a gamma radiation detector configured to detect gamma rays emitted from the formation as a result of interactions of the pulsed neutrons with elements within the formation;
a computing device configured to:
receive data indicative of the detected gamma rays,
use the data to generate an inelastic scattering spectrum, wherein the inelastic scattering spectrum comprises:
peaks indicative of gamma rays arising from inelastic scattering interactions between the pulsed neutrons and the at least two elements, and
a background signal,
remove the background signal from the inelastic scattering spectrum to yield a background-corrected inelastic spectrum,
deconvolve the background-corrected inelastic spectrum to yield concentrations of the at least two elements, and
determine the ratio of the at least two elements.

12. The system of claim 11, wherein the at least two elements comprise carbon and oxygen.

13. The system of claim 11, wherein the PNG is configured so that:
during a pulse cycle, the PNG repeatedly pulses for a first duration, followed by a second duration during which the PNG is inactive; and
following the pulse cycle, the PNG remains inactive for a third duration.

14. The system of claim 13, wherein detecting the gamma rays comprises detecting gamma rays emitted during the first, second, and third durations.

15. The system of claim 14, wherein:
gamma rays detected during the first duration comprise gamma rays arising from inelastic scattering interactions, gamma rays arising from capture interactions, and background radiation, and
gamma rays detected during the first duration comprise gamma rays arising from capture interactions, and background radiation, and
gamma rays detected during the third duration comprises naturally occurring radiation.

16. The system of claim 15, wherein generating an inelastic scattering spectrum comprises subtracting gamma rays arising from capture interactions and naturally occurring radiation from the gamma rays detected during the first duration.

17. The system of claim 11, wherein removing the background signal from the inelastic scattering spectrum comprises using a Sensitive Nonlinear Iterative Peak (SNIP) algorithm.

18. The system of claim 11, wherein deconvolving the background-corrected inelastic spectrum comprises using a plurality of elemental standard spectra as basis functions to reconstruct the inelastic spectrum and wherein deconvolving the background-corrected inelastic spectrum comprises removing background signal from each of the elemental standard spectra.

19. The system of claim 11, wherein the background signal arises from one or more of events occurring within a scintillation material of the gamma radiation detector, the tool's housing, and/or the formation.

20. The system of claim 19, wherein the events occurring within the scintillation material comprise one or more of Compton scattering events, bremsstrahlung radiation, and characteristic X-rays.
